(19) United States
(12) Patent Application Publication
(10) Pub. No.: US 2024/0302989 A1
(43) Pub. Date: Sep. 12, 2024

(54) APPLICATION-CONSISTENT SNAPSHOTS

(71) Applicant: INTERNATIONAL BUSINESS MACHINES CORPORATION, ARMONK, NY (US)

(72) Inventors: Gang Lyu, Shanghai (CN); Yun Feng Ma, Beijing (CN); Jing Zhao, Beijing (CN); Fu Long Wang, Beijing (CN); Fang Yuan Cheng, Beijing (CN); Wei Gong, Beijing (CN)

(21) Appl. No.: 18/179,502

(22) Filed: Mar. 7, 2023

(51) Int. Cl. G06F 3/06; G06F 11/14

(52) U.S. Cl. CPC G06F 3/065; G06F 3/062; G06F 3/067; G06F 11/1461; G06F 11/1464

(57) ABSTRACT

Described are techniques for application-consistent snapshots. The techniques include determining that a scheduled snapshot of a storage volume is imminent, where the storage volume stores input/output (I/O) data associated with an application that executes on a host server. The techniques further include initiating at least one host buffer flush prior to the scheduled snapshot being performed, where I/O data in a host buffer associated with the application is transferred to a write cache of the storage volume to reduce an amount of I/O data in the host buffer when performance of the scheduled snapshot begins. The techniques further include initiating, after the host buffer flush has completed, a write cache flush to write the I/O data in the write cache to the storage volume. The techniques further include initiating the scheduled snapshot of the storage volume in response to an indication that the write cache flush has completed.

### BACKGROUND

The present disclosure relates to fault tolerance for computing systems, and, more specifically, to generating a snapshot using application level consistent data.

In computer systems, a snapshot represents the state of a system at a particular point in time. The snapshot is a point-in-time copy of a storage volume or a set of storage volumes, and the snapshot can be used to restore data to the storage volume or set of storage volumes when warranted. Application-consistent data protection ensures database consistency prior to creating a storage volume snapshot. Creating an application-consistent snapshot interrupts application processing because the application-consistent snapshot is made after making sure that current application operations are temporarily ceased (e.g., quiesced), and any data in memory is flushed to disk.

### SUMMARY

Aspects of the present disclosure are directed toward a computer-implemented method comprising determining that a scheduled snapshot of a storage volume is imminent, where the storage volume stores input/output (I/O) data associated with an application that executes on a host server. The computer-implemented method further comprising initiating at least one host buffer flush prior to the scheduled snapshot being performed, where I/O data in a host buffer associated with the application is transferred to a write cache of the storage volume to reduce an amount of I/O data in the host buffer when performance of the scheduled snapshot begins, which is expected to shorten a time to perform the scheduled snapshot. The computer-implemented method further comprising initiating, in response to an indication that the host buffer flush has completed, a write cache flush to write the I/O data in the write cache to the storage volume. The computer-implemented method further comprising initiating the scheduled snapshot of the storage volume in response to an indication that the write cache flush has completed.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 is a block diagram illustrating an example computational environment implementing an application-consistent snapshot system, in accordance with some embodiments of the present disclosure.

FIG. 2 is a sequence diagram that illustrates interactions between the components of the application-consistent snapshot system of FIG. 1, in accordance with some embodiments of the present disclosure.

FIG. 3 is a flow diagram illustrating an example method for performing host buffer flushes, in accordance with some embodiments of the present disclosure.

FIG. 4 is a flow diagram that illustrates an example method for proactively flushing a host buffer to a storage volume prior to generating a scheduled snapshot of the storage volume, in accordance with some embodiments of the present disclosure.

FIG. 5 is a block diagram that illustrates an example computing environment in which aspects of the present disclosure can be implemented, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward generating a snapshot using application level consistent data while reducing an impact to application operations by proactively flushing I/O data prior to generating the snapshot. While not limited to such applications, embodiments of the present disclosure may be better understood in light of the aforementioned context.

Periodically creating a snapshot of a storage volume allows a state of an application to be recovered in the event of a failure. The snapshot contains the state of the application at a single point-in-time, as well as other critical information that can be used to restore the state of the application. Snapshots can be scheduled. Snapshot scheduling automatically creates snapshots of designated storage volumes at a configured scheduled interval of time (e.g., every hour, day of the month, designated month, or a particular day of the week based on a configured time interval).

Creating a snapshot requires a brief interruption in access to a storage volume. The interruption allows backup processing to obtain a consistent point-in-time snapshot of the storage volume. The mechanism for interrupting access to the storage volume is generally referred to as a quiesce. To quiesce is to pause writes of application related I/O to a storage volume in order to achieve a consistent state in preparation for creating the snapshot. This generally involves flushing any outstanding writes from a data buffer to a respective storage volume. While creating the snapshot can take just a few seconds, the process of reaching a quiesced state can take longer due to the time needed to flush the outstanding writes to the storage volume. In particular, when a data buffer is fairly full, flushing the outstanding writes to the storage volume can increase the time to reach a quiesced state that allows a snapshot of the storage volume to be created.

Prior to the present disclosure, there has been no coordinator component to coordinate backup operations between applications and storage systems when creating a snapshot of a storage volume. This absence of coordination between an application and a storage system has generally resulted in longer interruptions of access to a storage volume during the snapshot creation process. For example, prior to the present disclosure, no proactive backup preparations were coordinated between the application and storage system to decrease a time needed to reach a quiesced state, and reduce an overall backup time during which the application's access to the storage volume is blocked.

Advantageously, aspects of the present disclosure overcome these challenges by coordinating operations to proactively flush I/O data to a storage volume prior to a scheduled snapshot of the storage volume. More specifically, aspects of the present disclosure determine that a scheduled snapshot of a storage volume is imminent (e.g., scheduled to be performed in the immediate future), and in response, aspects of the present disclosure initiate at least one host buffer flush prior to the scheduled snapshot being performed. Performing a host buffer flush transfers I/O data contained in a host buffer to a write cache of a storage volume, which reduces the amount of I/O data that may need to be flushed to the storage volume during performance of the scheduled snapshot and is expected to decrease an overall time to perform the scheduled snapshot. In response to an indication that the host buffer flush has completed, aspects of the present disclosure initiate a write cache flush which writes the I/O data contained in the write cache to the storage volume. Thereafter, aspects of the present disclosure initiate the scheduled snapshot of the storage volume.

Accordingly, aspects of the present disclosure provide improvements to a computer-related technology that optimize the snapshot process by shortening an overall time in which an application's access to a storage volume is blocked. Shortening the time in which an application is blocked from access to a storage volume (referred to herein as an I/O block) reduces incidents of backup failures.

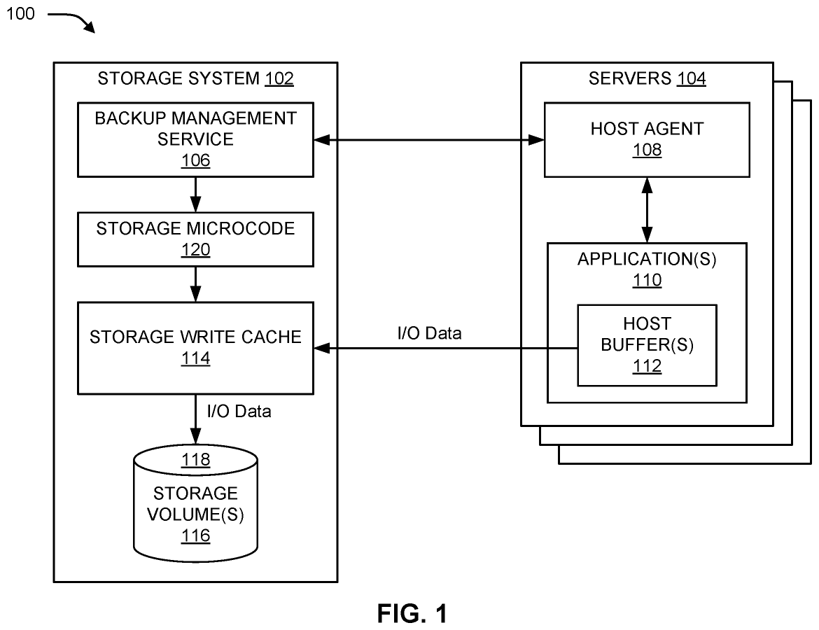

Referring now to the figures, FIG. 1 illustrates a block diagram of an example computational environment 100 that can implement a backup management service 106 to coordinate snapshot operations between applications 110 and storage volumes 116, in accordance with some embodiments of the present disclosure. The applications 110 and the storage volumes 116 comprise a consistency group. The consistency group allows simultaneous snapshots of the storage volumes 116 to be created using application-consistent data at a particular point in time.

As shown, the computational environment 100 includes a storage system 102 configured to provide a data management platform for collecting and managing data associated with one or more applications 110 hosted on one or more servers 104. The storage system 102 includes data storage devices 118 containing storage volumes 116. A storage volume 116 comprises an identifiable unit of data storage on a physical or virtual disk that provides persistent block storage space to applications 110. Applications 110 comprise computer programs, processes, web applications, mobile applications, containerized workloads, and the like. The storage volumes 116 managed by the storage system 102 are provisioned to the applications 110 to enable the applications 110 to write I/O data (e.g., data representing the state of an application 110) to the storage volumes 116. Generally, an application 110 temporarily stores I/O data to an application host buffer (shown as host buffer 112), and at some point, the I/O data is written to a storage volume 116 provisioned to the application 110. Writing the I/O data contained in the host buffer 112 to the storage volume is generally referred to as buffer flushing.

The backup management service 106 configures, manages, and monitors snapshot operations to create and delete application-consistent snapshots of storage volumes 116 that can be used to restore an application's state (e.g., a user state in the application 110 and a computational state of the application 110). The backup management service 106 can automate the administration and configuration of snapshot operations, including scheduling snapshot operations based on backup frequency and retention, as defined in a backup policy. The backup management service 106 can provide a graphical interface and/or a command line interface for configuring and managing snapshot operations across storage volumes 116 via the backup policy.

According to aspects of the present disclosure, the backup management service 106 is configured to reduce an impact to an application's operations during a backup of the application's storage volume 116 by reducing an amount of data in the application's host buffer 112 prior to performing the backup operation. Performing a backup of an application's storage volume 116 typically requires quiescing the storage volume 116 to allow backup processing to obtain an application-consistent point-in-time snapshot of the storage volume 116. Illustratively, quiescing the storage volume 116 can comprise flushing the application's host buffer(s) 112 to the storage volume 116, blocking application I/O data write operations, and waiting for currently executing storage volume operations to complete. Once the storage volume 116 has been quiesced, the snapshot can be created. Thereafter, application I/O write operations are allowed and the storage volume 116 can be returned to normal operations. While creating the snapshot can take just a few seconds, the process of reaching the quiesced state may take longer due to a time needed to flush the application's host buffer 112 to the storage volume 116. For example, when the application's host buffer 112 contains a large amount of I/O data, flushing the I/O data to the application's storage volume 116 increases the time to reach a quiesced state that allows a snapshot of the storage volume 116 to be created. The backup management service 106 is configured to shorten the time to reach a quiesced state by proactively flushing I/O data from the application's host buffer 112 to the application's storage volume 116 prior (e.g., immediately prior) to a scheduled backup of the storage volume 116, as described below. Flushing the I/O data from the application's host buffer 112 to the application's storage volume 116 immediately before a scheduled backup allows a snapshot to be generated using application-consistent data and reduces an impact to the application's ability to write I/O data to the application's storage volume 116.

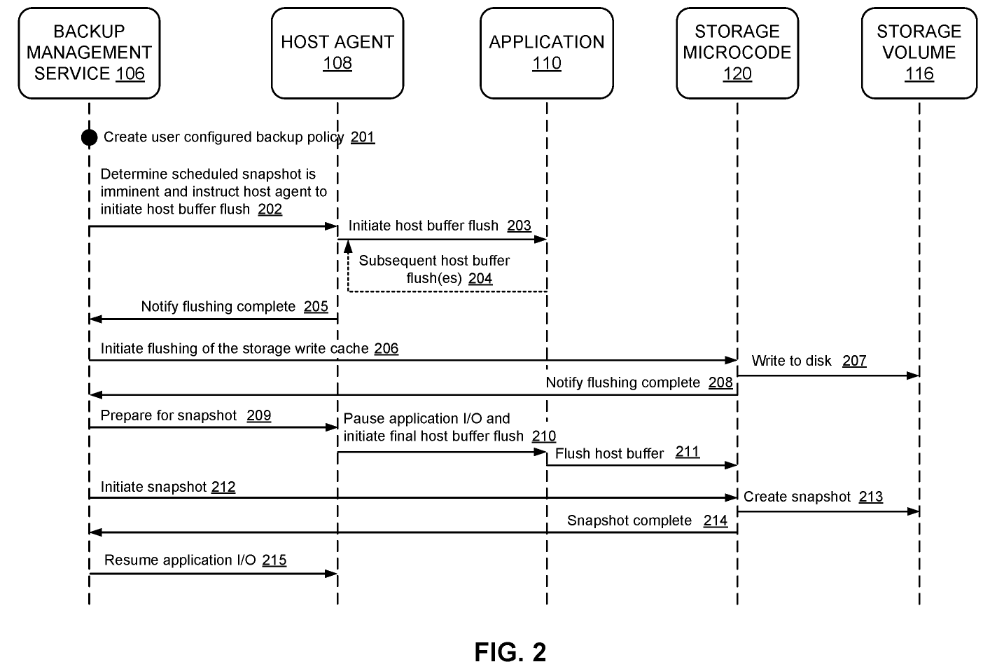

In some embodiments, as shown in FIG. 2 and with continuing reference to FIG. 1, the backup management service 106 manages the backup process by coordinating with a host agent 108 to initiate one or more host buffer flushes prior to a scheduled snapshot being performed. In some embodiments, the operations of the example method 200 described in association with FIG. 2 can be applied to a consistency group of one or more applications 110 and one or more storage volumes 116, which in some embodiments, can be distributed among a plurality of computing nodes. In cases where a consistency group of applications 110 and storage volumes 116 are distributed among computing nodes, a host agent 108 on each node coordinates with the backup management service 106 to perform the operations of the method 200 (to flush I/O data from respective host buffers 112 to respective storage volumes 116) substantially at the same time (e.g., within a few milliseconds or seconds) to synchronize creation of the snapshots of the storage volumes 116.

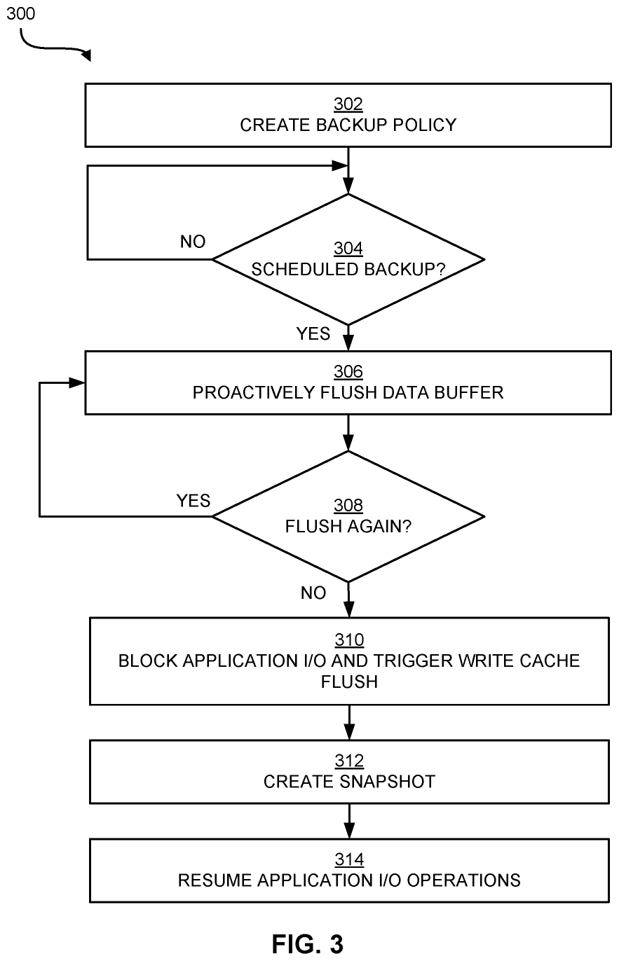

Initially, in operation 201, a user creates and configures a backup policy for a consistency group of one or more applications 110 and one or more storage volumes 116. The backup policy defines parameters for performing a backup of the one or more storage volumes 116, including parameters for scheduling a snapshot of the one or more storage volume 116. For example, the backup policy can specify a time, an interval, a condition, etc. for initiating a backup of the one or more storage volumes 116. The backup policy can also define parameters associated with proactively flushing a host buffer 112 to a respective storage volume 116 prior to a scheduled snapshot, as described later in association with FIG. 3.

In operation 202, the backup management service 106 monitors the storage system 102 via the backup policy to determine that the performance of a scheduled snapshot is imminent. As an example, the backup management service 106 can obtain from the backup policy a start time of a scheduled snapshot. As another example, the backup management service 106 can obtain from the backup policy a condition (e.g., time since last backup, storage maintenance process, etc.) that triggers a backup operation, and the backup management service 106 can monitor the storage system 102 to detect when the condition occurs or is impending.

In some embodiments, as part of determining that performance of a scheduled snapshot is imminent, the backup management service 106 determines a time to start proactively flushing a host buffer 112 to a respective storage volume 116. The flush start time can be determined by calculating an expected duration of the host buffer flush, which can be based on historical flush times associated with the host buffer 112 and the storage volume 116. In some embodiments, a predicted host buffer flush duration can be calculated using an exponential moving average method, defined as:

$$EMA\_Buffer \_Flush {\_Duration}_{N} = ( 1 - a ) \cdot EMA\_Buffer \_Flush {\_Duration}_{N - 1} + a \cdot Buffer\_Flush {\_Duration}_{N}$$

Where a is a constant for a given moving average defined to determine the weight between the current data and the historical data. A different decision window can be configured for the exponential moving average method according to the scheduling parameters for a scheduled backup (e.g., twenty-four hours, seven days, etc.).

Continuing with operation 202, after determining that the scheduled snapshot is imminent, the backup management service 106 instructs a host agent 108 to initiate one or more host buffer flushes. A host agent 108 comprises a software agent, computer program, or the like that executes on a server 104 that hosts an application(s) 110. A host agent 108 can be located on each server 104 that hosts one or more applications 110. For example, in a distributed system scenario that distributes applications 110 among a number of servers 104 (e.g., nodes), a host agent 108 can be installed on each of the servers 104 to enable the backup management service 106 to coordinate proactive flushing of host buffer(s) 112 on the servers 104 just prior to performing scheduled backup operations. The host agent(s) 108 manages host buffer flushing operations for the application(s) 110 as instructed by the backup management service 106.

In response to receiving an instruction from the backup management service 106 to initiate a host buffer flush, the host agent 108, in operation 203, initiates the host buffer flush by instructing an application 110 to flush pending writes (i.e., I/O data) contained in one or more host buffers 112 to a storage write cache 114 of the storage system 102. Generally, an application 110 (e.g., a database application) buffers I/O data in one or more host buffers 112 prior to the I/O data being written to a storage volume 116 managed by a storage system 102. A host buffer 112 comprises a portion of computer memory that is allocated to an application 110 for buffering of the application's I/O data, where the computer memory is located on a server 104 that hosts the application 110. Application I/O data can be transferred over a network (not shown) that enables communication between the storage system 102 and the server 104. Illustratively, a host agent 108 can initiate a host buffer flush using an application command that causes an application 110 to process pending writes to a storage volume 116. As a non-limiting example, the host agent 108 can initiate a host buffer flush using the fsync( ) function to force a physical write of data from a host buffer 112 (e.g., buffer cache) to a storage volume 116 (e.g., physical storage device). For example, in the context of the MONGODB® application, the fsync( ) function with the lock parameter set to false forces a flush of pending writes from a buffer cache to a physical storage device without blocking writes of new I/O data to the buffer cache. This allows flushing of the buffer cache multiple times prior to performing a scheduled snapshot, such that when the scheduled snapshot is performed, synchronizing pending writes to the physical storage device will take less time as compared to not proactively flushing the buffer cache prior to the scheduled snapshot.

After completion of a host buffer flush, the host agent 108 determines whether a subsequent host buffer flush is needed. A method of determining whether to perform subsequent host buffer flushes is described later in more detail in association with FIG. 3. In the case that the host agent 108 determines to perform a subsequent host buffer flush, then in operation 204, the host agent 108 instructs the application 110 to perform another flush of the host buffer 112. When the host agent 108 has determined that host buffer flushing is complete (as per the method described in association with FIG. 3), the host agent 108 sends a notification to the backup management service 106 indicating that the host buffer flushing is complete, as in operation 205. In the example of a distributed system, a host agent 108 located on each node of the distributed system performs the host buffer flushing technique described above and sends a notification to the backup management service 106 after the host buffer flushing has been completed.

As previously mentioned, flushing the host buffer 112 transfers application I/O data to the storage write cache 114 of the storage system 102, which is referred to as write caching, and which typically comprises a process whereby a storage device does not immediately write all I/O data to a storage volume 116, but instead caches some part of the I/O data in a storage write cache 114 to complete writing to the storage volume 116 at a later time. However, aspects of the present disclosure change this process by performing a write cache flush upon completion of one or more host buffer flushes. More specifically, after host buffer flushing is complete, the host agent 108 notifies the backup management service 106 and, in response, the backup management service 106 causes the storage system 102 to write any I/O data contained in the storage write cache 114 to the storage volume 116 located on a physical storage device (e.g., storage disk), as in operation 206. Accordingly, instead of caching the I/O data in the storage write cache 114 for writing to the storage volume 116 at a later time, the backup management service 106 directs the storage system 102 to write the I/O data contained in the storage write cache 114 to the storage volume 116, as in operation 207. As shown in FIG. 1, in some embodiments, the backup management service 106 sends a command to storage microcode 120 to flush the storage write cache 114. The storage microcode 120 can comprise a layer of hardware-level instructions that implement a write cache flush of the storage write cache 114 in response to receiving a command to do so.

After flushing of the storage write cache 114 is complete, the storage microcode 120, in operation 208 of FIG. 2, notifies the backup management service 106 that the storage write cache 114 has been flushed. As shown in operation 209, the backup management service 106 then instructs the host agent 108 to prepare for the scheduled snapshot by instructing the application 110 to pause I/O storage operations and perform a final flush of the host buffer(s) 112. In response, as in operation 210, the host agent 108 instructs the application 110 to cease application I/O storage operations and perform a final host buffer flush. In operation 211, the application performs the final host buffer flush.

Thereafter, in operation 212, the backup management service 106 initiates the snapshot backup operation by instructing the storage microcode 120 to create the snapshot. The storage microcode 120 quiesces the storage volume 116 by blocking application I/O data write operations to the storage write cache 114 and flushing the storage write cache 114 to the storage volume 116. In operation 213, the storage microcode 120 then creates the snapshot of the storage volume 116. Illustratively, the storage microcode 120 creates a reservation on each storage volume 116 included in the consistency group. While a reservation exists, any new writes that require data to be stored in the snapshot will be created synchronously. In the example where the storage system 102 is a distributed system, this process will be performed substantially at the same time on each node included in the distributed system.

In operation 214, the storage microcode 120 notifies the backup management service 106 that the snapshot has been created. In response to the notification, the backup management service 106, in operation 215, sends an instruction to the host agent 108 to resume application I/O storage operations. Resumption of application I/O storage operations allows the application 110 to resume normal operations that write I/O data to the storage volume 116.

With continuing reference to FIG. 1, illustrated in FIG. 3 is an example method 300 for performing host buffer flushes, in accordance with some embodiments of the present disclosure. Starting with operation 302, as described earlier, a user can create and configure a backup policy for a consistency group of one or more applications 110 and one or more storage volumes 116. The backup policy defines parameters for performing a backup of the consistency group. The parameters can be defined to balance the two opposite objectives of minimizing a time that application I/O storage operations are blocked and minimizing a time to generate a snapshot. These parameters include: one or more scheduling parameters specifying a time, an interval, a condition, etc. for initiating a scheduled snapshot, and parameters for proactively flushing one or more host buffers 112 to respective storage volumes 116 immediately prior to the scheduled snapshot.

In operation 304, the method 300 obtains scheduling parameter(s) from the backup policy and determines a start time of a scheduled snapshot of storage volumes 116 included in the consistency group. In some embodiments, the method 300 monitors relevant components (e.g., a system clock, system resource demand, etc.) of the storage system 102 to detect that a scheduled snapshot is imminent. As shown in operation 304, in the case that a scheduled snapshot is not imminent, the method 300 continues to monitor the storage system 102 until the method 300 determines that a scheduled snapshot is imminent.

In operation 306, in response to a determination that a scheduled snapshot is imminent (e.g., within a few minutes or seconds), the method 300 proactively flushes one or more host buffers 112 to one or more storage volumes 116, as described earlier in association with FIG. 2. The one or more host buffer(s) 112 can be flushed multiple times prior to a scheduled snapshot to decrease I/O data in the host buffer(s) 112 to an amount defined by the backup policy.

More specifically, the backup policy can include parameters for proactively flushing host buffers 112 that include a maximum data threshold parameter, a maximum allowed flushes parameter, and a maximum duration parameter. The maximum data threshold parameter specifies a threshold amount of I/O data allowed to remain in a host buffer 112 after performance of a host buffer flush. For example, during performance of a host buffer flush, or immediately after the host buffer flush, an application 110 can write new I/O data to the host buffer 112. As such, upon completion of the buffer flush, the host buffer 112 may contain newly added I/O data. In such cases, additional host buffer flushes can be performed contingent on the parameters defined by the backup policy described below.

In some embodiments, performance of a subsequent host buffer flush is contingent on the maximum data threshold parameter defined by the backup policy. The maximum data threshold parameter determines whether a subsequent host buffer flush can be performed based on whether an amount of new I/O data in the host buffer 112 exceeds the maximum data threshold parameter. In operation 308, if the amount of new I/O data exceeds the maximum data threshold defined by the backup policy, a subsequent host buffer flush can be performed. In some embodiments, the maximum data threshold parameter can be calculated as a ratio of a current amount of I/O data contained in the host buffer 112 to the buffer size. In other embodiments, the maximum data threshold parameter can be set to an absolute data amount.

Performance of additional host buffer flushes can also be conditioned on a maximum number of buffer flushes that are allowed to be performed and/or a maximum amount of time that is allowed to perform buffer flushes. For example, in some embodiments, performance of a subsequent buffer flush is contingent on the maximum allowed flushes parameter defined by the backup policy. The maximum allowed flushes parameter specifies a maximum number of host buffer flushes that are allowed to be performed immediately before a scheduled snapshot. For example, as described above, an application 110 may write I/O data to the host buffer 112 during or immediately after performance of a host buffer flush, and if an amount of new I/O data in the host buffer 112 exceeds the maximum data threshold parameter, then a subsequent host buffer flush can be performed up to a number of times specified by the maximum allowed flushes parameter. Accordingly, in the case that new I/O data in the host buffer 112 exceeds the maximum data threshold parameter and the number of host buffer flushes performed does not equal or exceed the maximum allowed flushes parameter, then the method 300 returns to operation 306 to perform a subsequent host buffer flush. However, if the number of host buffer flushes performed equals or exceeds the maximum allowed flushes parameter, another host buffer flush is not allowed and the method continues to operation 310.

Also, in some embodiments, performance of a subsequent host buffer flush is contingent on the maximum duration parameter defined by the backup policy. The maximum duration parameter specifies an aggregate execution time in which proactive host buffer flush operations are allowed to execute. Again, as described above, multiple host buffer flushes can be performed based on whether an amount of new I/O data in a host buffer 112 exceeds the maximum data threshold. An aggregate time of the host buffer flushes can be monitored, and if the aggregated time equals or exceeds the maximum duration parameter, then subsequent host buffer flushes may not be allowed. As a non-limiting example, in the case that new I/O data in the host buffer 112 exceeds the maximum data threshold parameter and the aggregate time of the host buffer flushes does not equal or exceed the maximum duration parameter, then the method 300 returns to operation 306 to perform a subsequent host buffer flush. If the aggregate time of the host buffer flushes does equal or exceed the maximum allowed flushes parameter, the method 300 does not allow another host buffer flush to be performed, and the method continues to operation 310.

In some embodiments, performance of additional host buffer flushes can be subject to both the maximum allowed flushes parameter and/or the maximum duration parameter. As a non-limiting example, in the case that new I/O data in the host buffer 112 exceeds the maximum data threshold parameter, an additional host buffer flush can be performed if the number of host buffer flushes performed does not equal or exceed the maximum allowed flushes parameter and the total time of the host buffer flushes does not equal or exceed the maximum duration parameter. However, if either of the maximum allowed flushes parameter and the maximum duration parameter are satisfied, then another host buffer flush is not allowed and the method continues to operation 310.

In operation 310, the method 300 blocks application I/O and triggers a write cache flush as described earlier. In operation 312, the method 300 creates the snapshot of the storage volume(s) 116, and thereafter, resumes application I/O operations at operation 314.

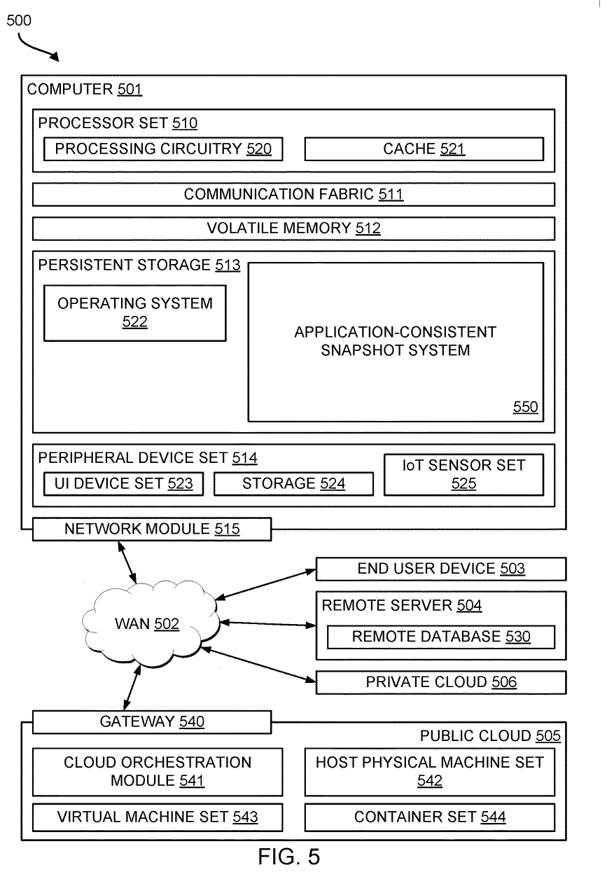

In the illustrative examples described above, the backup management service 106, host agent 108, and storage microcode 120 can be implemented in software, hardware (e.g., shown in FIG. 5), firmware or a combination thereof. When software is used, the operations described above can be implemented in program instructions configured to run on hardware, such as a processor unit. When firmware is used, the operations performed can be implemented in program instructions and data and stored in persistent memory to run on a processor unit. As used herein, a processor unit is a hardware device and is comprised of hardware circuits such as integrated circuits that respond to and process instructions and program instructions that operate a computer. A processor unit can be implemented using a processor set. When processor units execute program instructions for a process, the number of processor units can be one or more processor units that are on the same computer or on different computers. In other words, the process can be distributed between processor units on the same or different computers in the computational environment 100. Further, the number of processor units can be of the same type or different type of processor units. For example, the number of processor units can be selected from at least one of a single core processor, a dual-core processor, a multi-processor core, a general-purpose central processing unit (CPU), a graphics processing unit (GPU), a digital signal processor (DSP), or some other type of processor unit.

In some embodiments, the backup management service 106, the host agent 108, and/or the storage microcode 120 can be implemented as modules or services that send and receive requests and provide output to one another. An application programming interface (API) can be provided for each module or service to enable a first module to send requests to and receive output from a second module. A network (not shown) can be provided to enable communication between the components of the computational environment 100. The network can include any useful computing network, including an intranet, the Internet, a local area network, a wide area network, a wireless data network, or any other such network or combination thereof. Components utilized for the network can depend at least in part upon the type of network and/or environment selected. Communication over the network can be enabled by wired or wireless connections and combinations thereof.

In the illustrative examples above, the same reference numeral may be used in more than one figure. This reuse of a reference numeral in different figures represents the same element in the different figures. The illustration of the computational environment 100 is not meant to imply physical or architectural limitations to the manner in which an illustrative embodiment can be implemented. Other components in addition to or in place of the ones illustrated may be used. Also, the blocks are presented to illustrate some functional components. One or more of these blocks may be combined, divided, or combined and divided into different blocks when implemented in an illustrative embodiment. While FIG. 1 illustrates an example of an environment that can implement the techniques above, many other similar or different environments are possible. The example environments discussed and illustrated herein are merely representative and not limiting.

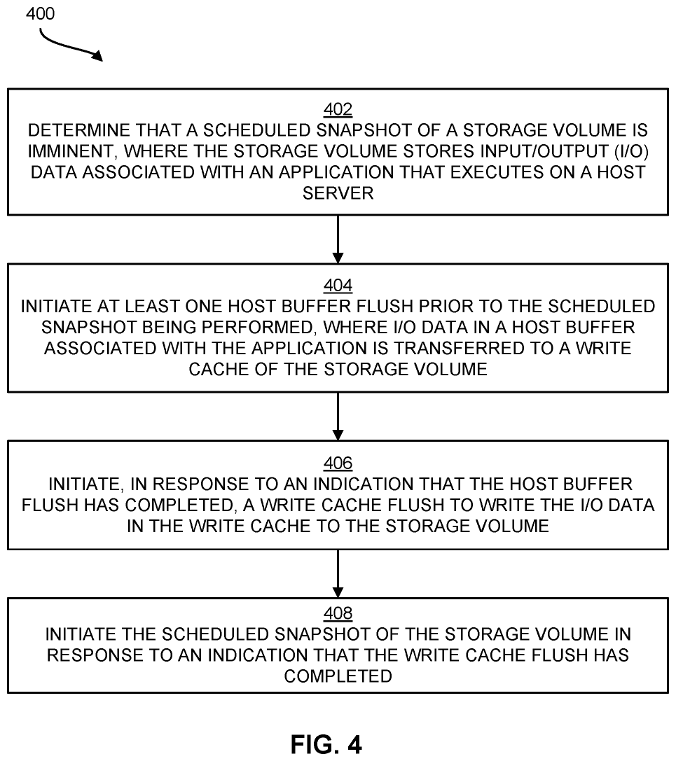

FIG. 4 is a flow diagram illustrating an example method 400 for proactively flushing a host buffer to a storage volume prior to generating a scheduled snapshot of the storage volume, in accordance with some embodiments of the present disclosure. In some embodiments, the method 400 can be applied to a consistency group of a plurality of applications and storage volumes to allow simultaneous snapshots to be created using application-consistent data. Also, in some embodiments, the applications and storage volumes are part of a distributed system, and the operations of the method 400 are performed on each node of the distributed system at substantially the same time to synchronize performance of the operations.

In operation 402, the method 400 determines that a scheduled snapshot of a storage volume is imminent, where the storage volume stores I/O data associated with an application that executes on a host server. In some embodiments, determining that the scheduled snapshot of the storage volume is imminent includes calculating an estimated duration to flush I/O data to the storage volume, and determining a flush start time based on the estimated flush duration. Thereafter, the host buffer flush can be initiated at the flush start time prior to performance of the scheduled snapshot of the storage volume.

In operation 404, the method 400 initiates at least one host buffer flush prior to the scheduled snapshot being performed. The host buffer flush includes transferring I/O data contained in a host buffer associated with the application to a write cache of the storage volume. Performing the host buffer flush reduces the amount of I/O data in the host buffer when performance of the scheduled snapshot begins, thereby potentially lessening the time to perform the scheduled snapshot.

In some embodiments, performing the host buffer flush includes obtaining a backup policy for scheduled snapshots that defines a maximum data threshold parameter, which specifies a threshold amount of I/O data (e.g., newly added I/O data) that can remain in the host buffer after performance of a host buffer flush. The maximum data threshold parameter can be used to determine whether to perform a subsequent host buffer flush to clear the I/O data from the host buffer. For example, after performance of a first host buffer flush, if newly added I/O data contained in the host buffer exceeds the maximum data threshold parameter, a second host buffer flush can be initiated to transfer the newly added I/O data in the host buffer to the write cache of the storage volume.

In some embodiments, the backup policy can also define a maximum allowed flushes parameter and/or a maximum duration parameter. The maximum allowed flushes parameter indicates a maximum number of host buffer flushes that are allowed to be performed prior to a scheduled snapshot. The maximum duration parameter indicates a maximum total time for performing host buffer flushes prior to a scheduled snapshot. Accordingly, in some embodiments, additional host buffer flushes can be initiated until one of the following conditions occurs: an amount of newly added I/O data in a host buffer is below the maximum data threshold parameter, or a total number of host buffer flushes equals the maximum allowed flushes parameter, or an aggregate execution time of the host buffer flush operations equals the maximum duration parameter.

In operation 406, the method 400 initiates, in response to an indication that the host buffer flush has completed, a write cache flush to write the I/O data in the write cache to the storage volume. In operation 408, the method 400 initiates the scheduled snapshot of the storage volume in response to an indication that the write cache flush has completed. It will be appreciated that the method 400 can be performed by a computer (e.g., computer 501 in FIG. 5), performed in a cloud environment (e.g., clouds 506 or 505 in FIG. 5), and/or generally can be implemented in fixed-functionality hardware, configurable logic, logic instructions, etc., or any combination thereof.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code involved in performing the disclosed methods, such as block 550 which contains computer code for an application-consistent snapshot system comprising a backup management service and one or more host agents, as described earlier. In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 521 and the other storage media discussed below. The computer readable program instructions, and associated data, are accessed by processor set 510 to control and direct performance of the disclosed methods. In computing environment 500, at least some of the instructions for performing the disclosed methods may be stored in block 550 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code included in block 550 typically includes at least some of the computer code involved in performing the disclosed methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the disclosed methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

What is claimed is:

1. A computer-implemented method comprising:
determining that a scheduled snapshot of a storage volume is imminent, wherein the storage volume stores input/output (I/O) data associated with an application that executes on a host server;
initiating at least one host buffer flush prior to the scheduled snapshot being performed, wherein I/O data in a host buffer associated with the application is transferred to a write cache of the storage volume to reduce an amount of I/O data in the host buffer when performance of the scheduled snapshot begins, which is expected to shorten a time to perform the scheduled snapshot;
initiating, in response to an indication that the host buffer flush has completed, a write cache flush to write the I/O data in the write cache to the storage volume; and
initiating the scheduled snapshot of the storage volume in response to an indication that the write cache flush has completed.

2. The computer-implemented method of claim 1, further comprising obtaining a backup policy for the scheduled snapshot of the storage volume, wherein the backup policy defines:
a maximum data threshold parameter specifying a threshold amount of newly added I/O data in the host buffer used to determine whether a subsequent host buffer flush is performed,
a maximum allowed flushes parameter specifying a maximum number of host buffer flushes that are allowed to be performed, and
a maximum duration parameter specifying a maximum total time in which to perform host buffer flush operations.

3. The computer-implemented method of claim 2, wherein initiating the at least one host buffer flush further comprises:
determining that after performance of a first host buffer flush, the amount of newly added I/O data in the host buffer exceeds the maximum data threshold parameter defined by the backup policy; and
initiating a second host buffer flush to transfer the newly added I/O data to the write cache of the storage volume.

4. The computer-implemented method of claim 3, further comprising initiating additional host buffer flushes until at least one selected from a group consisting of:
the amount of I/O data in the host buffer is below the maximum data threshold parameter defined by the backup policy,
a total number of host buffer flushes equals the maximum allowed flushes parameter defined by the backup policy, and
an aggregate execution time of the host buffer flush operations equals the maximum duration parameter defined by the backup policy.

5. The computer-implemented method of claim 1, wherein initiating the scheduled snapshot of the storage volume comprises:
blocking new I/O data associated with the application from being written to the storage volume;
creating a snapshot of the storage volume; and
resuming application I/O storage operations in response to an indication that the snapshot has been created.

6. The computer-implemented method of claim 1, wherein determining that the scheduled snapshot of the storage volume is imminent further comprises:
calculating an estimated duration to flush the I/O data associated with the application to the storage volume; and
determining a flush start time based on the estimated flush duration, wherein the at least one host buffer flush is initiated at the flush start time prior to the scheduled snapshot of the storage volume.

7. The computer-implemented method of claim 1, wherein the application and the storage volume further comprise a consistency group of a plurality of applications and storage volumes to allow simultaneous snapshots to be created using application-consistent data.

8. The computer-implemented method of claim 7, wherein the plurality of applications and storage volumes are part of a distributed system, and operations to reduce the amount of I/O data in a host buffer associated with each of the plurality of applications prior to the scheduled snapshot are performed on each node of the distributed system at substantially the same time to synchronize performance of the operations.

9. A system comprising:
one or more computer readable storage media storing program instructions and one or more processors which, in response to executing the program instructions, are configured to:
determine that a scheduled snapshot of a storage volume is imminent, wherein the storage volume stores input/output (I/O) data associated with an application that executes on a host server;
initiate at least one host buffer flush prior to the scheduled snapshot being performed, wherein I/O data in a host buffer associated with the application is transferred to a write cache of the storage volume to reduce an amount of I/O data in the host buffer when performance of the scheduled snapshot begins, which is expected to shorten a time to perform the scheduled snapshot;
initiate, in response to an indication that the host buffer flush has completed, a write cache flush to write the I/O data in the write cache to the storage volume; and
initiate the scheduled snapshot of the storage volume in response to an indication that the write cache flush has completed.

10. The system of claim 9, wherein the program instructions are further configured to cause the one or more processors to obtain a backup policy for the scheduled snapshot of the storage volume, wherein the backup policy defines:
a maximum data threshold parameter specifying a threshold amount of newly added I/O data in the host buffer used to determine whether a subsequent host buffer flush is performed,
a maximum allowed flushes parameter specifying a maximum number of host buffer flushes that are allowed to be performed, and
a maximum duration parameter specifying a maximum total time in which to perform host buffer flush operations.

11. The system of claim 10, wherein the program instructions configured to cause the one or more processors to initiate the at least one host buffer flush are further configured to cause the one or more processors to:
determine that after performance of a first host buffer flush, the amount of newly added I/O data in the host buffer exceeds the maximum data threshold parameter defined by the backup policy; and
initiate a second host buffer flush to transfer the newly added I/O data to the write cache of the storage volume.

12. The system of claim 11, wherein the program instructions are further configured to cause the one or more processors to initiate additional host buffer flushes until at least one selected from a group consisting of:
the amount of I/O data in the host buffer is below the maximum data threshold parameter defined by the backup policy,
a total number of host buffer flushes equals the maximum allowed flushes parameter defined by the backup policy, and
an aggregate execution time of the host buffer flush operations equals the maximum duration parameter defined by the backup policy.

13. The system of claim 9, wherein the program instructions configured to cause the one or more processors to initiate the scheduled snapshot of the storage volume are further configured to cause the one or more processors to:
block new I/O data associated with the application from being written to the storage volume;
create a snapshot of the storage volume; and
resume application I/O storage operations in response to an indication that the snapshot has been created.

14. The system of claim 9, wherein the program instructions configured to cause the one or more processors to determine that the scheduled snapshot of the storage volume is imminent are further configured to cause the one or more processors to:
calculate an estimated duration to flush the I/O data associated with the application to the storage volume; and
determine a flush start time based on the estimated flush duration, wherein the at least one host buffer flush is initiated at the flush start time prior to the scheduled snapshot of the storage volume.

15. A computer program product comprising:
one or more computer readable storage media, and program instructions collectively stored on the one or more computer readable storage media, the program instructions configured to cause one or more processors to:
determine that a scheduled snapshot of a storage volume is imminent, wherein the storage volume stores input/output (I/O) data associated with an application that executes on a host server;
initiate at least one host buffer flush prior to the scheduled snapshot being performed, wherein I/O data in a host buffer associated with the application is transferred to a write cache of the storage volume to reduce an amount of I/O data in the host buffer when performance of the scheduled snapshot begins, which is expected to shorten a time to perform the scheduled snapshot;
initiate, in response to an indication that the host buffer flush has completed, a write cache flush to write the I/O data in the write cache to the storage volume; and
initiate the scheduled snapshot of the storage volume in response to an indication that the write cache flush has completed.

16. The computer program product of claim 15, wherein the program instructions are further configured to cause the one or more processors to obtain a backup policy for the scheduled snapshot of the storage volume, wherein the backup policy defines:
a maximum data threshold parameter specifying a threshold amount of newly added I/O data in the host buffer used to determine whether a subsequent host buffer flush is performed,
a maximum allowed flushes parameter specifying a maximum number of host buffer flushes that are allowed to be performed, and
a maximum duration parameter specifying a maximum total time in which to perform host buffer flush operations.

17. The computer program product of claim 16, wherein the program instructions configured to cause the one or more processors to initiate the at least one host buffer flush are further configured to cause the one or more processors to:
determine that after performance of a first host buffer flush, the amount of newly added I/O data in the host buffer exceeds the maximum data threshold parameter defined by the backup policy; and
initiate a second host buffer flush to transfer the newly added I/O data to the write cache of the storage volume.

18. The computer program product of claim 17, wherein the program instructions are further configured to cause the one or more processors to initiate additional host buffer flushes until at least one selected from a group consisting of:
the amount of I/O data in the host buffer is below the maximum data threshold parameter defined by the backup policy,
a total number of host buffer flushes equals the maximum allowed flushes parameter defined by the backup policy, and
an aggregate execution time of the host buffer flush operations equals the maximum duration parameter defined by the backup policy.

19. The computer program product of claim 15, wherein the program instructions configured to cause the one or more processors to initiate the scheduled snapshot of the storage volume are further configured to cause the one or more processors to:
block new I/O data associated with the application from being written to the storage volume;
create a snapshot of the storage volume; and
resume application I/O storage operations in response to an indication that the snapshot has been created.

20. The computer program product of claim 15, wherein the program instructions configured to cause the one or more processors to determine that the scheduled snapshot of the storage volume is imminent are further configured to cause the one or more processors to:
calculate an estimated duration to flush the I/O data associated with the application to the storage volume; and
determine a flush start time based on the estimated flush duration, wherein the at least one host buffer flush is initiated at the flush start time prior to the scheduled snapshot of the storage volume.
